(19) United States
(12) Patent Application Publication
(10) Pub. No.: US 2015/0039623 A1
(43) Pub. Date: Feb. 5, 2015

(54) SYSTEM AND METHOD FOR INTEGRATING DATA

(71) Applicants: Yogesh Pandit, Haledon, NJ (US); Ashay Chaudhary, Redmond, WA (US)

(72) Inventors: Yogesh Pandit, Haledon, NJ (US); Ashay Chaudhary, Redmond, WA (US)

(21) Appl. No.: 14/447,316

(22) Filed: Jul. 30, 2014

Related U.S. Application Data
(60) Provisional application No. 61/859,773, filed on Jul. 30, 2013.

(51) Int. Cl. G06F 17/30

(52) U.S. Cl. CPC G06F 17/30557
USPC 707/740

(57) ABSTRACT

Disclosed is a method for integrating multiple data sets in a single operation. The method comprises categorizing one or more dimensions and/or attributes from each data set into a context category list. Further, the method includes defining relationships between dimensions and/or attributes in the context category list into related sets. Furthermore, the method includes feeding the data sets and context category list to a computing device. Moreover, the method includes computing deterministically unique identifier from the values of the dimensions and/or attributes in the context category list for each tuple in each data set. Also, the method includes storing the identifier and original tuple in an identifier-tuples list. Thereafter, the method includes merging all tuples with identical identifiers with matching values for dimensions and/or attributes in the context category list. Finally, the method includes creating defined target data set structure from all entries from the identifier-tuples list.

### CROSS-REFERENCE TO RELATED APPLICATIONS

This application claims the benefit of U.S. Provisional Patent Application No. 61/859,773, filed on Jul. 30, 2013, now pending, which patent application is incorporated here by reference in its entirety to provide continuity of disclosure.

### FIELD OF THE INVENTION

The present invention provides a system and method for integrating data, and more particularly, the present invention relates to a system and method for semantic, multi-dimensional data integration.

### BACKGROUND OF THE INVENTION

The prior art has systems and methods available for data integration from a maximum of two data sources. These systems and methods integrate data but are unable to meet the needs of the industry because they are limited to two data sets at a time, and/or require the source data set to be modified or manipulated before the system and methods can integrate successfully. Further, the prior art systems and methods can integrate only when the data sources have at least one dimension with unique values to match records. Other systems and methods that attempt multiple data set integration are also available in the prior art. However, these solutions do not meet the needs of the industry because they only perform a simple join operation and not the multiple types of joins defined by industry standards.

Further, other systems available in the art seek to integrate data from multiple data sets, but these systems also fail to meet industry needs because they are not able to match records with data that is literally different but semantically identical.

Currently, organizations store their data in relational databases and/or data files from various computer applications. The relational databases provide several methods to retrieve data from multiple tables within a database, using commands like JOIN on a field common to both tables, GROUP BY to restrict the operation to return a subset of data, and the like. As organizational needs have resulted in a multitude of applications that store the data in databases (each with their own schemas), it is difficult and laborious to integrate the data from multiple databases using existing tools. Moreover, it is almost impossible when there is no common identity to correlate the data contained in the different databases or non-database data sources. The prior art data integration systems employ fuzzy or set-similarity joins using the MapReduce process for exact matching, in addition to the usual approximate matching techniques, such as locality-sensitive hashing.

Therefore, data integration solutions that integrate data from multifarious high volume data sources, ranging from SQL to text or binary data sources, having structured as well as unstructured data and complex data relationships to provide comprehensive analytics and reporting are absent in the prior art. Further, the prior art data integration solutions do not interface seamlessly with traditional and leading edge systems for optimal performance, and do not intelligently analyze user-defined relationships and provide effective complex heuristic data to integrate with major Big Data and NoSQL products that involves machine learning in a heuristic manner.

Accordingly, there exists a need to provide an intelligent system and method that uses fuzzy join or set-similarity joins using approximate as well as exact matching techniques for heuristic data integration of a high volume of data gathered from a very broad variety of data sources which overcomes the abovementioned drawbacks.

### SUMMARY OF THE INVENTION

Accordingly, the present invention provides a method for integrating multiple data sets in a single operation. The method comprises categorizing one or more dimensions and/or attributes from each data set into a context category list. Further, the method includes defining relationships between dimensions and/or attributes in the context category list into related sets. Furthermore, the method includes feeding the data sets and the context category list to a computing device. Moreover, the method includes computing a deterministically unique identifier from the values of the dimensions and/or attributes in the context category list for each tuple in each data set. Also, the method includes storing the identifier and the original tuple in an identifier-tuples list. Thereafter, the method includes merging all tuples with identical identifiers with matching values for dimensions and/or attributes in the context category list. Finally, the method includes creating a defined target data set structure from all entries from the identifier-tuples list.

### BRIEF DESCRIPTION OF THE DRAWINGS

FIG. 1 shows a schematic diagram of a system in accordance with the present invention;

FIG. 1A shows a flowchart of a process employed by the system in accordance with the present invention;

FIG. 2 shows tables of data from different data sources with one dimension/attribute categorized into a context category in accordance with the present invention;

FIG. 3 shows an intermediate data structure of the source data based on the values of the dimensions/attributes in accordance with the present invention;

FIG. 4 shows an integrated and aggregated data based on the values of the dimensions/attributes in the context category in accordance with the present invention;

FIG. 5 shows multiple dimensions/attributes categorized into the context category with relationships defined in accordance with the present invention;

FIG. 6 shows relationships between the dimensions/attributes and the confidence factors for each relationship in accordance with the present invention;

FIG. 7 shows semantic mappings of the data values as well as the preferred values;

FIG. 8 shows alternate data structures defined for the integrated and aggregated data in accordance with the present invention;

FIG. 9 shows an intermediate data structure when multiple dimensions/attributes have been categorized into the context category in accordance with the present invention;

FIG. 10 shows source data dimensions/attributes categorized into an additional category, the resulting intermediate data structure, and match scores based on the confidence factors as a function of the value matches between the data sources in accordance with the present invention;

FIG. 11 shows an integrated and aggregated data structure of the categorization and confidence factors of FIG. 10 in accordance with the present invention; and

FIG. 12 shows a flowchart that represents a method for semantic, multi-dimensional data integration.

### DETAILED DESCRIPTION OF THE INVENTION

The foregoing objects of the invention are accomplished and the problems and shortcomings associated with the prior art techniques and approaches are overcome by the present invention as described below in the preferred embodiment.

The present invention provides a system and method for integrating data. The system and method provides a semantic, multi-dimensional data integration which provides a computerized data process which simultaneously integrates multiple data sets from different sources into a single, de-duplicated data set using multi-dimensional mapping of semantically identical data. The present invention is a computerized data process to integrate multiple data sets in a single operation.

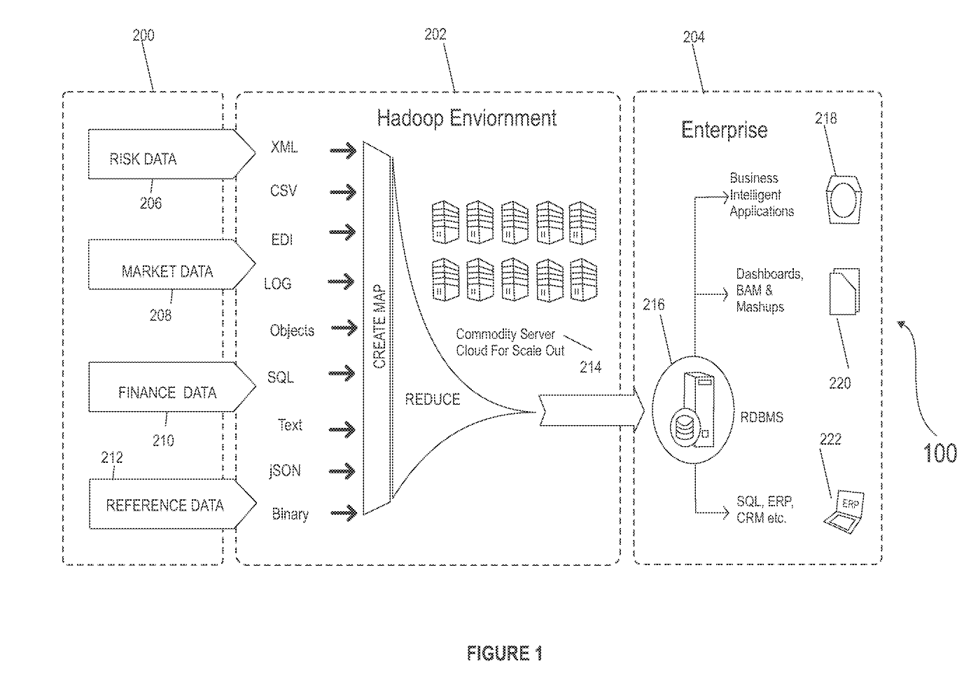

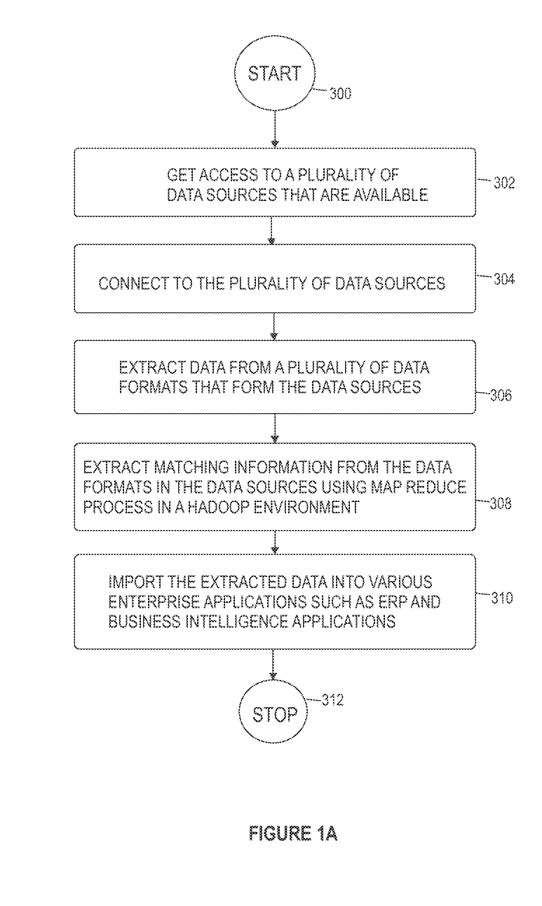

Referring to FIG. 1, the data integration system (100) in accordance with the present invention includes a high volume data source (202), a big data environment or MapReduce environment (204) that runs the MapReduce process. MapReduce is a programming model and associated implementation for processing and generating large data sets with a parallel, distributed algorithm on a cluster. The system processes a plurality of data sources that include a risk data source (206), a market data source (208), a finance data source (210), and a reference data source (212) having a plurality of formats ranging from Extensible Markup Language (XML) to Binary files. The MapReduce environment (204) marshals a plurality of distributed servers (214), runs various tasks in parallel, and manages all communications and data transfers between the various parts of the system. The data is fed by the data sources to the servers in the commodity server cloud. The MapReduce environment (204) also provides for redundancy and fault tolerance. Fuzzy or set-similarity joins preferably use the MapReduce process to provide an exact matching technique to return correct output every time. The exact matching techniques are based on similarity of sets and/or may be based on length/prefix-based methods. These techniques are preferably parallelized and a Hadoop environment, an open-source software framework for storage and large-scale processing of data-sets on clusters of commodity hardware, is used for the purpose. A software program that is configured and enabled communicate with the server cloud and the plurality of data sources automatically and manually is provided in the system. The big data processed inside the MapReduce environment (204) is exported to enterprise environment (206). The data first flows to a Relational Database Management System (RDBMS) and stored therein. From the RDBMS, the data is further processed for enterprise applications, such as, for example, business intelligent applications, dashboards and mashups, and Enterprise Resource Planning (ERP), Service Oriented Architecture (SOA) and Customer Relationship Management (CRM) applications and services.

Referring to FIG. 1A, a process employed by the system for semantic, multi-dimensional data integration is shown. The process for semantic, multi-dimensional data integration starts at step 300 and at step 302 the system gets access to the plurality of data sources available and moves to step 304. At step 304, the system (100) connects to the plurality of data sources (206, 208, 210 and 212) for extraction of data. The plurality of data sources (206, 208, 210 and 212) has a plurality of data formats such as, for example, Extensible Markup Language (XML), Extensible Stylesheet Language (XSL), Text files, Structured Query Language (SQL) files, Text files, JavaScript Object Notation (jSON) files, Comma Separated Value (CSV) files, Electronic Data Interchange (EDI) files, Log files and Objects, and the step moves to step 306. At step 306, the MapReduce processes are run in a Hadoop environment to extract matching information from the plurality of data formats that represent the plurality of data sources. The data provided by the data sources is preferably structured as in tables of an RDBMS. However, the system (200) is also capable of processing unstructured data.

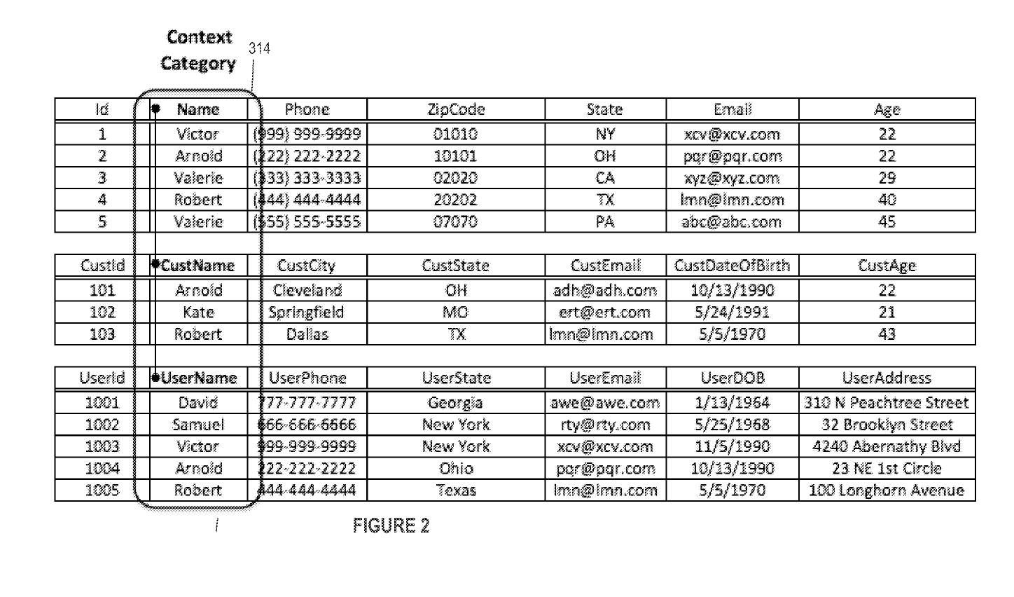

Referring to FIGS. 2-11, a method for semantic, multi-dimensional data integration received from a plurality of data sources having a plurality of formats is shown. The method comprises categorizing one or more dimensions and/or attributes from each data set into a context category list.

FIG. 2 shows a context category list and categorization wherein one or more dimensions and/or attributes from data sets are categorized into a context category list (314). Relationships between dimensions and/or attributes in the context category list (314) is defined into related sets. For example, the context category (314) categorizes “name of customer” from three different databases having three different column headings, such as, for example, “name”, “CustName” and “UserName”. Specifically, the method includes categorizing at least one dimension and/or attribute into a critical category, at least one dimension and/or attribute into a semi-critical category, and the remaining dimensions and/or attributes into a non-critical category. In this particular case, the dimension and/or attribute that is categorized into a critical category is the name of the customer. The dimension and/or attribute under the column headings “name”, “CustName” and “UserName” is categorized into a critical. category. The method defines relationships between dimensions and/or attributes in the context category list into related sets as shown. Specifically, the method includes defining semantic relationships between the dimensions and/or attributes in the context category. The method follows the semantic mapping technique for dimensionality reduction in a set of multidimensional vectors of features to extract a few new features that preserves the main data characteristics.

The data sources that provide data to the system (100) include databases and data that is received from different markets and different parts of the world. In each market or country the units for measuring, various data is different. Further, the currency might change according to some markets. For example, in some markets, the United States Dollar (USD) maybe currency used, whereas in some other markets Indian Rupee (INR) or Chinese Yuan Renminbi (CNY) may be the currency. In US, ‘million’, ‘billion’ are units for measuring money, whereas in Indian numbering system the units are ‘lakh’, ‘crore’. Further, the format for presenting a data, such as for example, date might be different. Therefore, integrating such a multi-dimensional data becomes critically important for markets such as, for example, financial markets. Decision making pertaining to areas such as, for example, risk management, is seriously affected, if the data is not integrated seamlessly and intelligently. Therefore, in such a scenario, machine learning based on heuristics becomes important. As more and more data is integrated in accordance with the system and method of the present invention, the data is integrated more intelligently based upon machine learning in a heuristic fashion.

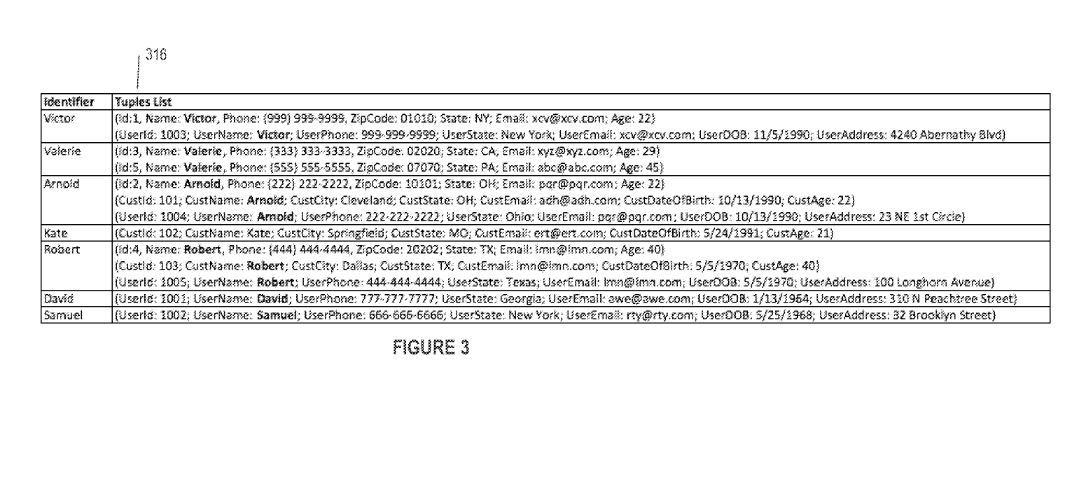

As shown in FIG. 3, a list of tuples (316) or rows of information belonging to each customer name from various databases is gathered. The method in accordance with the present invention computes a deterministically unique identifier from the values of the dimensions and/or attributes in the context category list for each tuple in each data set, and stores the identifier and the original tuple in an identifier-tuples list (316) as shown in FIG. 3. Specifically, each processing computing system scans each tuple from the original data sets, reads the values of the dimensions and/or attributes in the context category, generates a deterministically unique identifier for each tuple, and stores the unique identifier and the original tuple along with the original data set and tuple metadata into a sorted identifier-tuples list (316). If the deterministically unique identifier already exists in the identifier-tuples list, a secondary list consisting of the previous tuples and newly processed tuple is created for the existing identifier. All tuples with identical identifiers are merged with matching values for dimensions and/or attributes in the context category list.

For example, as shown in FIG. 3, each tuple contains information such as, for example, address, zipcode, email, phone numbers pertaining to a customer name from all the databases or data sources. The table contains duplicate values under the heading “tuples list” for each identifier who is a customer. For example, except the customer name “Kate”, other customer names “Victor”, “Valerie”, “Arnold”, “Robert”, “David” and “Samuel” have duplicate values. The dimensions, attributes and/or values with matched value into a single tuple are de-duplicated. The method includes taking preferred semantic value into a single tuple and extract unmatched tuples from the secondary lists into separate entries in the identifier-tuples list.

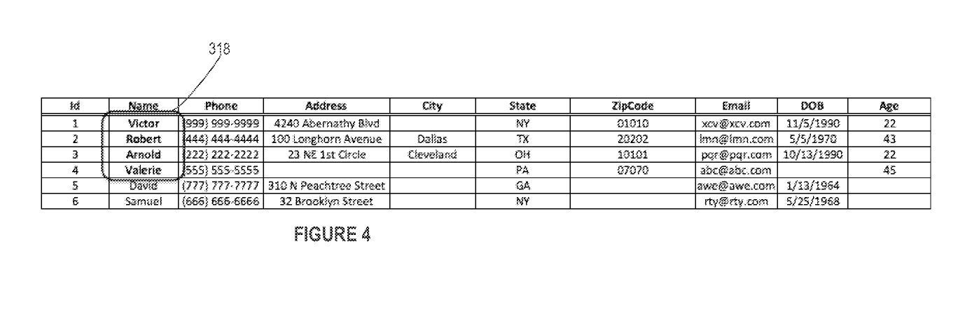

Further, as shown in FIG. 4, the names of customers are presented in a single table. A defined target data structure is created from all entries from the identifier-tuples list such that the customer names are represented by a set (318). The method in accordance with the present invention merges all tuples with identical identifiers with matching values for dimensions and/or attributes in the context category list. Therefore, in the table has no duplicate values for attributes for customer names, “Valerie”, “Victor”, “Arnold”, “Robert” in the set (318).

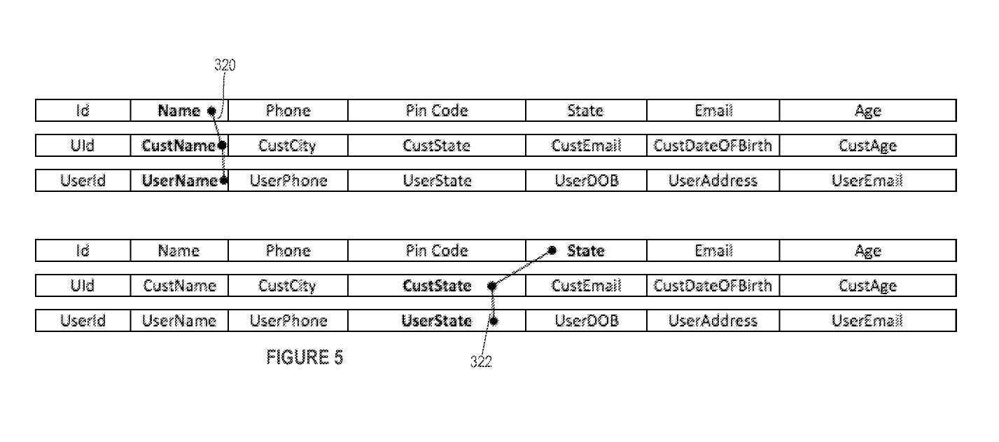

Additional dimensions and/or attributes are also categorized into the context category and one or more categories as shown in FIG. 5, wherein apart from customer names having of column headings (320) “Name”, “CustName” and “UserName”, the state names having column headings (322) “State”, “CustState” and “UserState” are semantically mapped. Thus, defined additional target data set structures are also created.

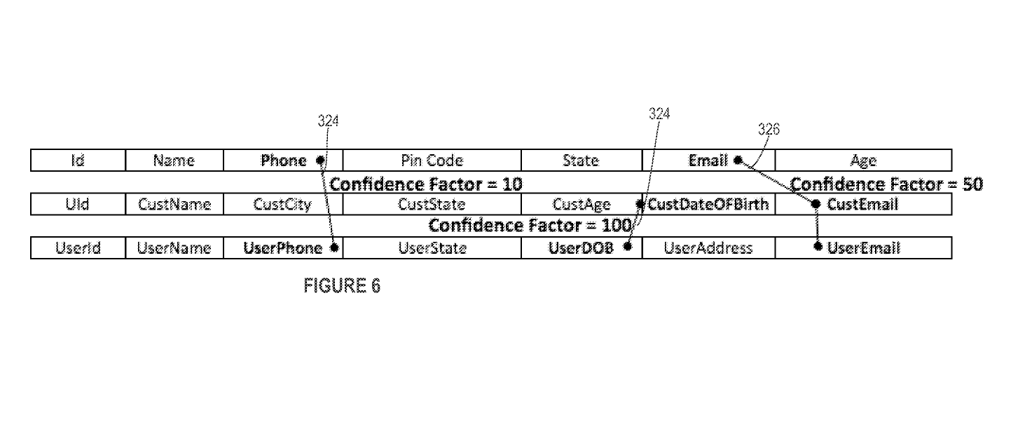

Referring to FIGS. 5-7, how the relationships between the dimensions/attributes and the confidence factors for each relationship is defined and determined is shown. FIG. 5 shows multiple dimensions/attributes categorized into the context category with relationships defined. Referring to FIG. 6, additional parameters for each defined category to control behavior of subsequent steps for each category are also defined and the method in accordance with the present invention compares the values of related dimensions and/or attributes in each category and increments a tuple match score by its confidence factor when there is an exact match. The method further compares literal and semantic values of related dimensions and/or attributes in each category and increment a tuple match score by its confidence factor when there is a semantic match. The dimensions and/or attributes not included in any category are ignored. Specifically, when the tuple match score exceeds the minimum threshold score, or continue until related dimension, the matching process is terminated attributes and/or values in one or more categories are compared.

For example, when initially there is an exact match of values of the dimension “phone” (324), the confidence factor is 10. The confidence factor further increases to 50 when the values of the dimension “email” (328) match. The confidence factor reaches a score of 100 when the values pertaining to the date of birth of the customer (326) also match.

In other words, confidence factor for values of related dimensions and/or attributes are matched and a minimum threshold score to signal an adequate match to merge tuples is defined. A matching algorithm is directed to control the behavior on reaching or exceeding a predefined minimum threshold score.

Specifically, the semantic value mappings with high confidence match scores for related dimensions and/or attributes in the critical category, appropriate semantic value mappings and confidence match scores for related dimensions and/or attributes in the semi-critical category. More specifically, the method includes defining a sufficiently high value for a minimum threshold score with a matching algorithm directive for thorough comparison of all dimensions and/or attributes in the critical and semi-critical categories. The matching algorithm tries to identify similar records using similar of sets and/or using the length- and/or prefix-based methods.

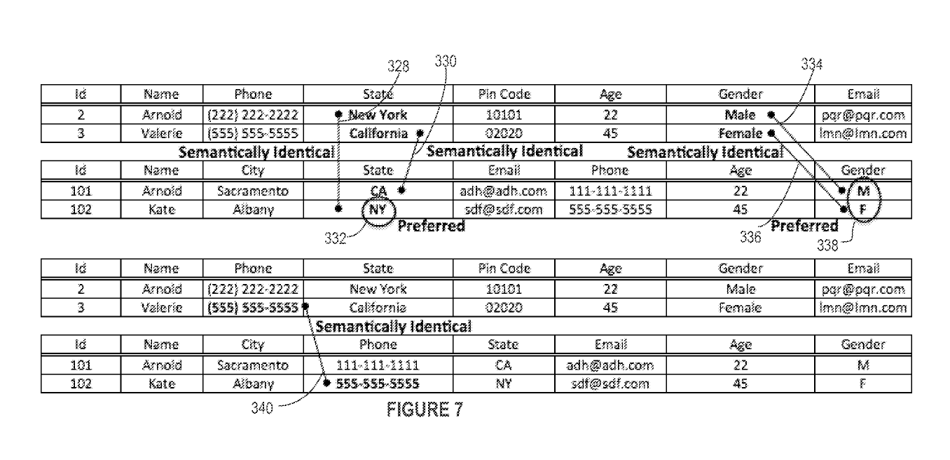

FIG. 7 illustrates how the confidence factor varies depending upon the context category. Semantically identical mappings for dimensions or attributes are defined by defining rules representing their semantic relationship and, optionally, the preferred semantic value. FIG. 7 shows the additional semantic mappings of the data values as well as the preferred values. The semantically identically values for name of states are “California”, “CA” (332) and “New York” and “NY” (330). The semantically identically values for gender are “Male” and “M” (336) and “Female” and “F” (338). The semantically identically values for telephone number are, for example “(555) 555-5555” and “555-555-5555 (342). The preferred semantic values such as, example, “NY” (334), “M”, “F” (340) are taken into a single tuple and extract unmatched tuples from the secondary lists into separate entries in the identifier-tuples list.

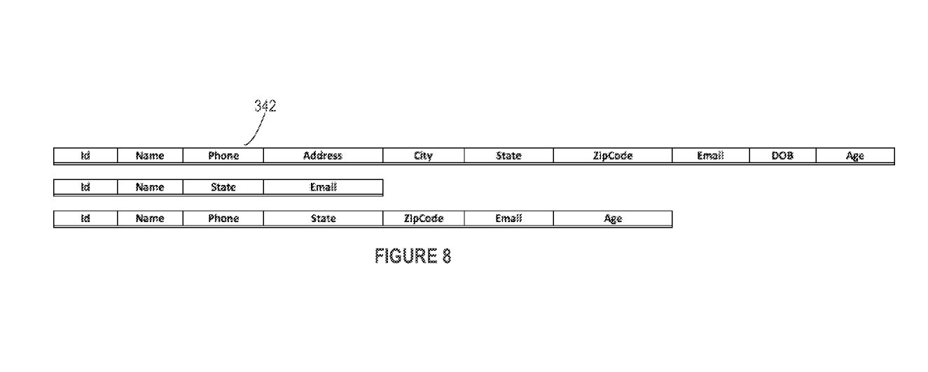

Referring to FIGS. 8-11, an intermediate data structure when multiple dimensions/attributes have been categorized into the context category is formed as shown in FIG. 8. Alternate target data structures (344) are also defined as shown in FIG. 8.

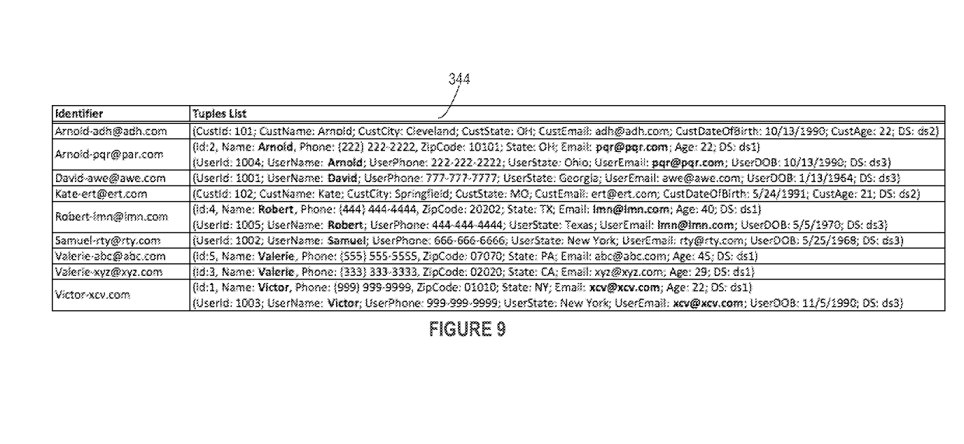

Referring to FIG. 9, the original data sets are received as a stream of tuples. The data sets are split into smaller sets and the processing is distributed across multiple computing systems. The data sets are fed as a stream of tuples to one or more processing computer systems. Deterministically unique identifiers are created from any combination values of dimensions and/or attributes in any combination of defined categories, metadata of original data set and tuple is added and identifier-tuples list (346) is sorted. The identifier used here is “email” of the client. The tuples contain all the information related to the identifier “email”. Finally, all tuples with identical identifiers are collated into a secondary list per identifier.

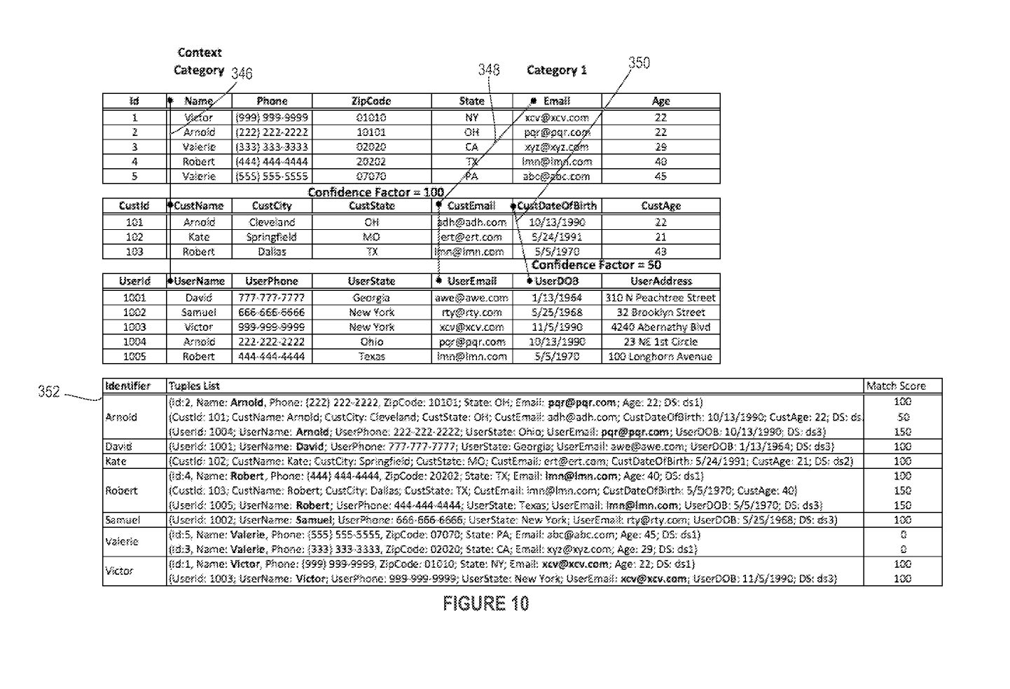

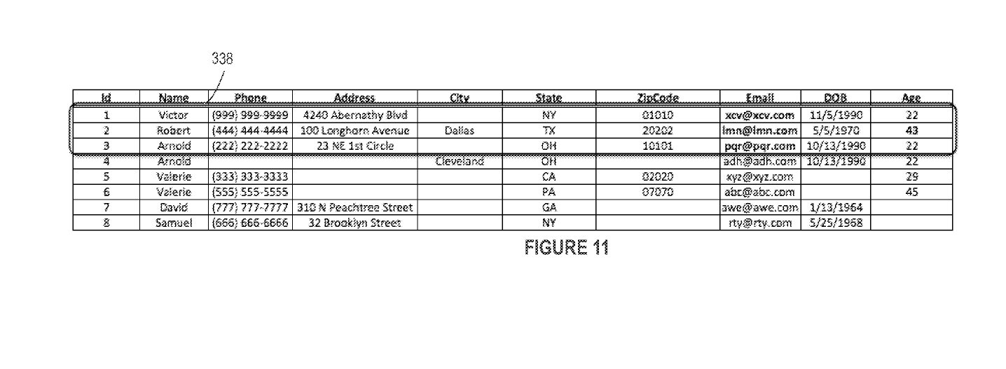

Referring to FIGS. 10-11, the values of related dimensions and/or attributes in each category are compared and a tuple match score is incremented by its confidence factor when there is an exact match. Literal and semantic values of related dimensions and/or attributes are compared and a tuple match score is incremented by the corresponding confidence factor when there is a semantic match. For example, when there is exact match of values of the dimension “date of birth” (350) the confidence factor is 50. The confidence factor further increases to 100, when the values of the dimension “email” (332) match.

All dimensions and/or attributes not included in any category are ignored. The matching process is terminated when the tuple match score exceeds the minimum threshold score, or continue until related dimension, attributes and/or values in one or more categories are compared as per a predefined required directive. Dimensions, attributes and/or values are de-duplicated with matched value into a single value. Then, dimensions, attributes and/or values are de-duplicated with semantic match by replacing the preferring with the preferred semantic value into a single tuple. Further, unmatched tuples from the secondary lists are extracted into separate entries in the identifier-tuples list (352). Finally, defined additional target data set structure are created if required earlier shown in FIG. 8.

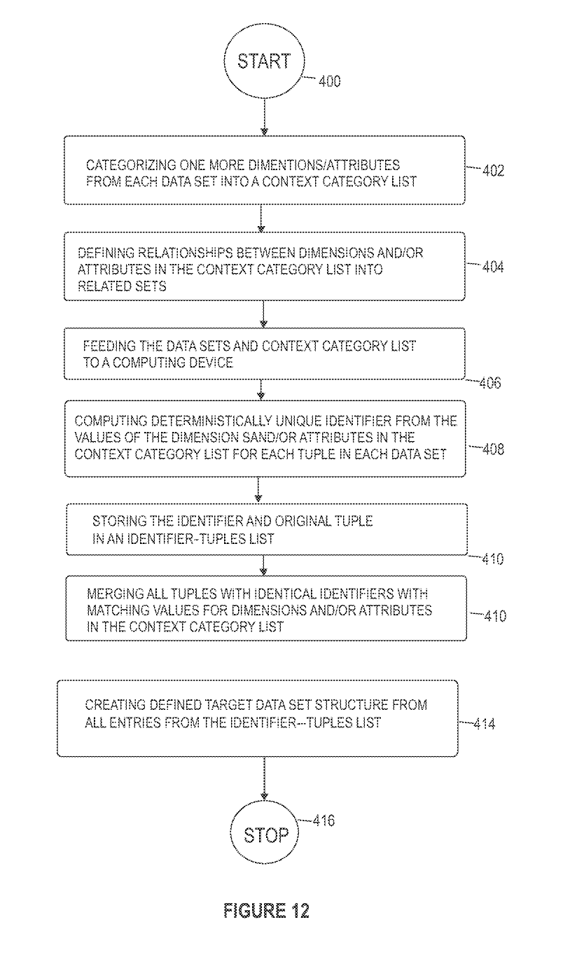

Referring to FIG. 12, a preferred method for semantic, multi-dimensional data integration in accordance with present invention is shown. The method starts at step 400 and at step 402 one or more dimensions and/or attributes from each data set are categorized into a context category list and the step moves to step 404. At step 404, the relationships between dimensions and/or attributes in the context category list are defined into related set and the method moves to step 406. At step 406, the data sets and context category list are fed to a computing device and the method moves to step 408. At step 408, deterministically unique identifier is computed from the values of the dimensions and/or attributes in the context category list for each tuple in each data set, and step moves to 410. At step 410, the identifier and original tuple is stored in an identifier-tuples list, and the method proceeds to step 412. At step 412, all tuples with identical identifiers are merged with matching values for dimensions and/or attributes in the context category list, and the process moves to step 414. At step 414, a defined target data set structure is created from all entries from the identifier-tuples list.

The present invention is unique and superior when compared to other known processes or solutions, because the present invention simultaneously integrates, merges and de-duplicates data from multiple different systems and sources without the existence of a common identifier typically required by existing processes or solutions, or requiring prior manipulation or modification of the source data. In order to accomplish this, the invention provides the information that defines a contextual identity based on the dimensions in the data sources. Users can also provide additional information for the invention to accurately integrate, merge and de-duplicate the data into a comprehensive data set. The additional information provided to the invention includes categorization and prioritization of dimensions and/or attributes, and relationships between the dimensions and/or attributes from different data sets. Moreover, this invention is primed with common patterns of semantically equivalent dimensions and/or values, and allows users to provide custom lists of semantically equivalent values.

Specifically, the semantic lists significantly simplify the integration task for users and provide significantly improved accuracy in matching related tuples for integration and de-duplication. The present invention provides unprecedented data integration capabilities for users. This invention is unique when compared to other known solutions because it simultaneously processes data from multiple data sources by accepting the data in its original format and performs multiple logical operations in one physical operation, thus simplifying the task for users. When the user deploys the invention on multiple computing systems, the invention divides the data set equitably across all systems and executes all processing in parallel to complete it in the shortest amount of time. This invention is also unique in its ability to process data in sets or streams of tuples as input to the invention and/or output from the invention. Furthermore, this invention is capable of simultaneously creating multiple formats of integrated data sets. Among other things, it is an object of the present invention to provide semantic, multi-dimensional data integrator that does not suffer from any of the problems or deficiencies associated with prior solutions. The foregoing description of the specific embodiments will so fully reveal the general nature of the embodiments herein that others can by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

We claim:

1. A method for integrating multiple data sets in a single operation, the method comprising:
categorizing one or more dimensions and/or attributes from each data set into a context category list;
defining relationships between the one or more dimensions and/or attributes in the context category list into related sets;
feeding the multiple data sets and the context category list to a computing device;
computing a deterministically unique identifier from values of the one or more dimensions and/or attributes in the context category list for each tuple in each data set,
storing the identifier and an original tuple in an identifier-tuples list;
merging all tuples with identical identifiers with matching values for the one or more dimensions and/or attributes in the context category list; and
creating a defined target data set structure from all entries from the identifier-tuples list.

2. The method of claim 1, wherein categorizing the one or more dimensions and/or attributes includes categorizing at least one dimension and/or attribute into a critical category, at least one dimension and/or attribute into a semi-critical category, and the remaining one or more dimensions and/or attributes into a non-critical category.

3. The method of claim 1, wherein the feeding of the multiple data sets into the computing device includes splitting the multiple data sets into smaller sets and distributing the smaller sets across multiple computing systems.

4. A system for semantic and multi-dimensional data integration, the system comprising:
a preconfigured and predefined access to a plurality of data sources that provide data in a plurality of formats;
a server cloud operating in a software framework for storage and large-scale processing of data sets on clusters of commodity hardware; and
a software program that is configured and enabled to (1) communicate with the server cloud and the plurality of data sources, to (2) automatically and manually categorize one or more dimensions and/or attributes from each data set into a context category list, to (3) define relationships between the one or more dimensions and/or attributes in the context category list into related sets and feed the data sets and the context category list to the server cloud and a plurality of computing devices, to (4) compute a deterministically unique identifier from values of the one or more dimensions and/or attributes in the context category list for each tuple in each data set, to (5) store the identifier and an original tuple in an identifier-tuples list, to (6) merge all tuples with identical identifiers with matching values for the one or more dimensions and/or attributes in the context category list, and to (7) create a defined target data set structure from all entries from the identifier-tuples list.
